(19) United States
(12) Patent Application Publication
(10) Pub. No.: US 2005/0274608 A1
(43) Pub. Date: Dec. 15, 2005

(54) Anion generator for use with a computer for cooling purpose

(76) Inventor: Li-Sheng Ko, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/865,787

(22) Filed: Jun. 14, 2004

(51) Int. Cl. H01M 2/14

(52) U.S. Cl. 204/230.2

(57) ABSTRACT

An anion generator is disclosed to include a housing, an anion-generating panel mounted inside the housing near the bottom side, a meshed conducting plate mounted inside the housing near the top side, and a high voltage generator mounted inside the housing, the high voltage generator having a positive lead wire connected to the meshed conducting plate and a negative lead wire connected to the anion-generating panel for causing the anion-generating panel to generate currents of anions for carrying heat from a computer supported on the housing when electrically connected.

### BACKGROUND OF THE INVENTION

1. Field of the Invention:

The present invention relates to an anion. generator and more particularly, to an anion generator specifically designed for use with a computer for cooling purpose.

2. Description of the Related Art:

FIG. 5 illustrates a cooling device 6 for use to cool a notebook computer. As illustrated, the cooling device 6 uses a set of electric fans 61 for causing currents of air to carry heat away from the notebook computer. This design of cooling device 6 has drawbacks as follows:

1. During operation, the electric fans 61 produce much noise.

2. The electric fans 61 consume much electric energy when working.

### SUMMARY OF THE INVENTION

The present invention has been accomplished under the circumstances in view. It is one object of the present invention to provide an anion generator, which produces currents of anions without noise when switched on. It is another object of the present invention to provide an anion generator, which uses a meshed conducting plate to concentrate currents of anion and to improve heat convection effect. It is still another object of the present invention to provide an anion generator, which saves much electric energy consumption.

To achieve these and other objects of the present invention, the anion generator comprises a housing, the housing having a top side, a bottom side, and a plurality of air vents in the top side and the bottom side; an anion-generating panel mounted inside the housing adjacent to the bottom side; a meshed conducting plate mounted inside the housing adjacent to the top side; and a high voltage generator mounted inside the housing, the high voltage generator having a positive lead wire connected to the meshed conducting plate and a negative lead wire connected to the anion-generating panel for causing the anion-generating panel to generate currents of anions when electrically connected.

### BRIEF DESCRIPTION OF THE DRAWINGS

FIG. 1 is an exploded view of an anion generator according to the present invention.

FIG. 2 is a sectional assembly view of the anion generator according to the present invention.

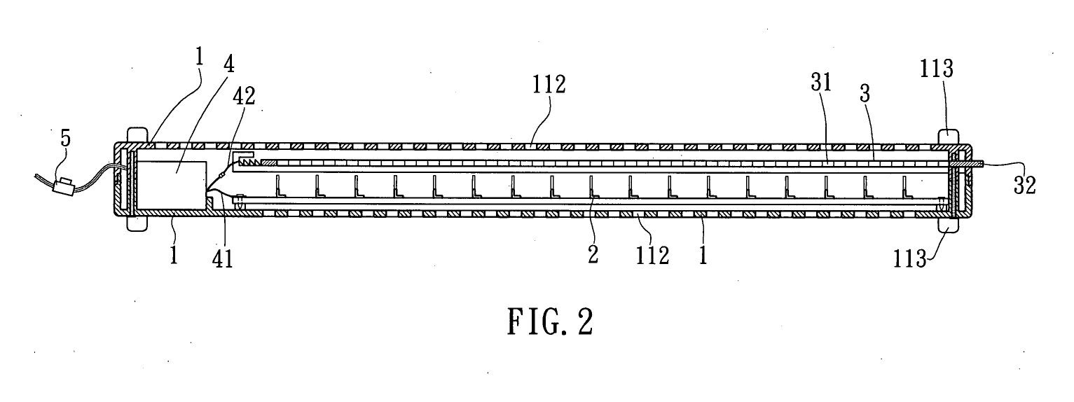

FIG. 3 is a perspective view of the anion generator according to the present invention.

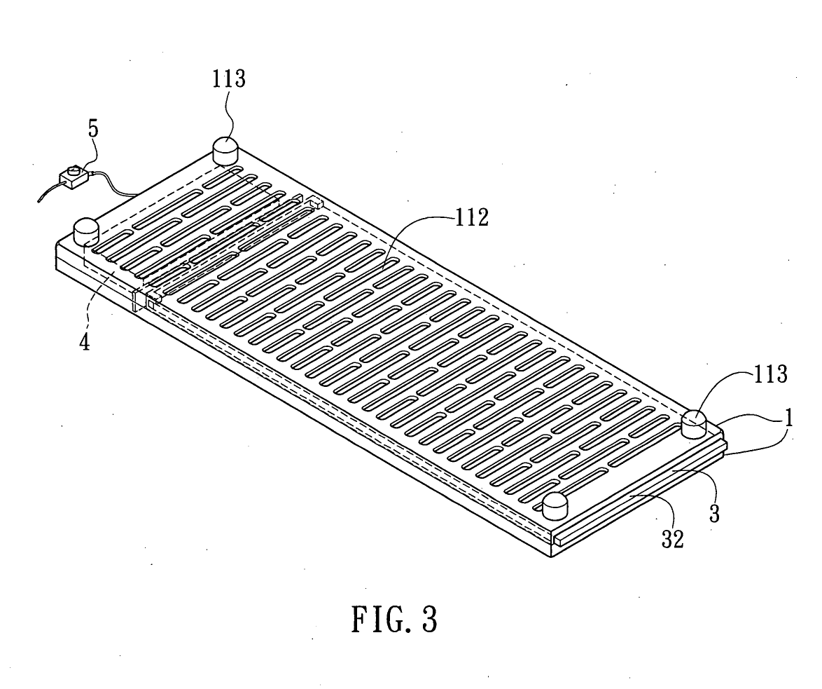

FIG. 4 is a schematic sectional view of the present invention showing the anion generator used in a computer.

FIG. 5 is a perspective view of a cooling device for use in a computer according to the prior art.

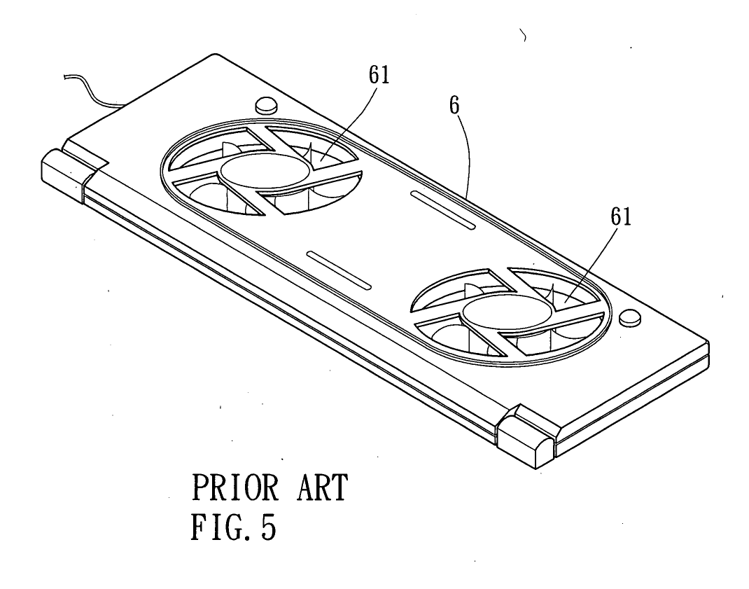

### DETAILED DESCRIPTION OF THE PREFERRED EMBODIMENT

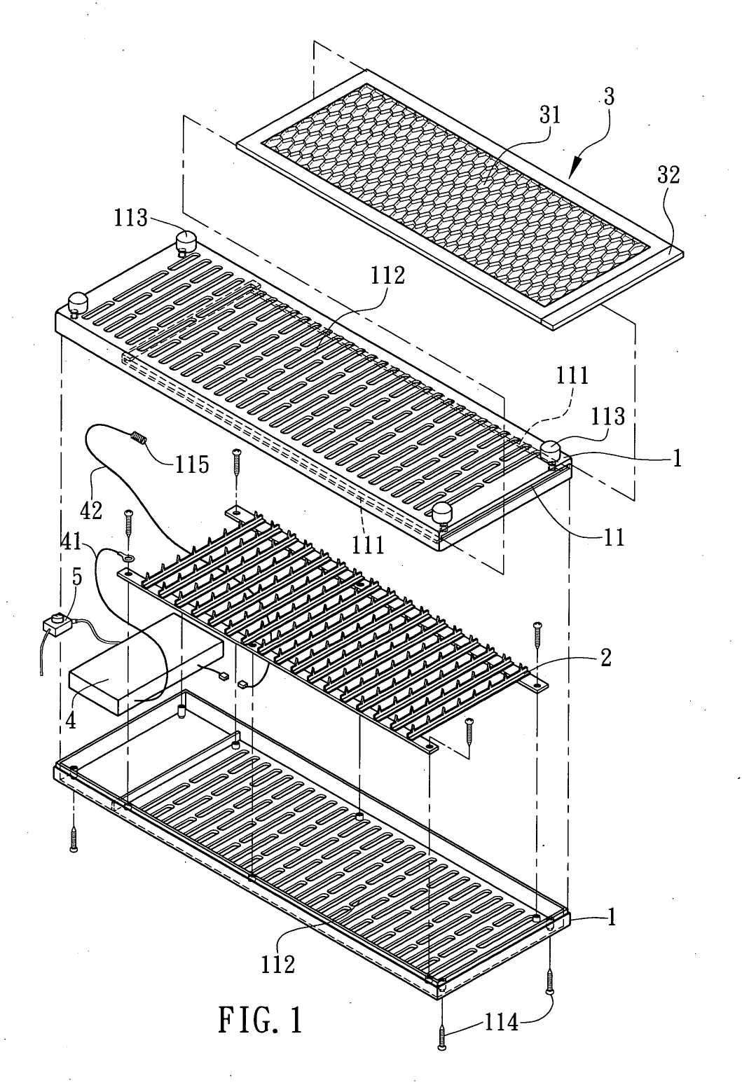

Referring to FIGS. 1˜4, an anion generator in accordance with the present invention is shown comprised of a housing 1, an anion-generating panel 2, a metal mesh plate 3, a high voltage generator 4, and a power control 5.

The housing 1 is formed of two symmetrical half shells fixedly fastened together with screws 114, having a plurality of air vents 112 in the top and bottom sides, a plurality of stub rods 113 respectively symmetrically provided at the top and bottom sides around the corners, an insertion hole 11 in one half shell at one end, and two sliding grooves 111 arranged in parallel in the same half shell in communication with the insertion hole 11. The anion-generating panel 2 is mounted inside the housing 1. The metal mesh plate 3 is inserted through the insertion hole 11 into the sliding grooves 111 inside the housing 1, having three-dimensional meshes 31. The high voltage generator 4 is mounted inside the housing 1, having a positive lead wire 42 connected to a metal spring 115 inside the housing 1 for the connection of the metal mesh plate 3 and a negative lead wire 41 connected to the anion-generating panel 2. The power control 5 is provided on the outside of the housing 1 and electrically connected to the high voltage generator 4 for power on/off and voltage level control. Further, the metal mesh plate 3 has one end provided with an insulative member 32 for the gripping of the hand.

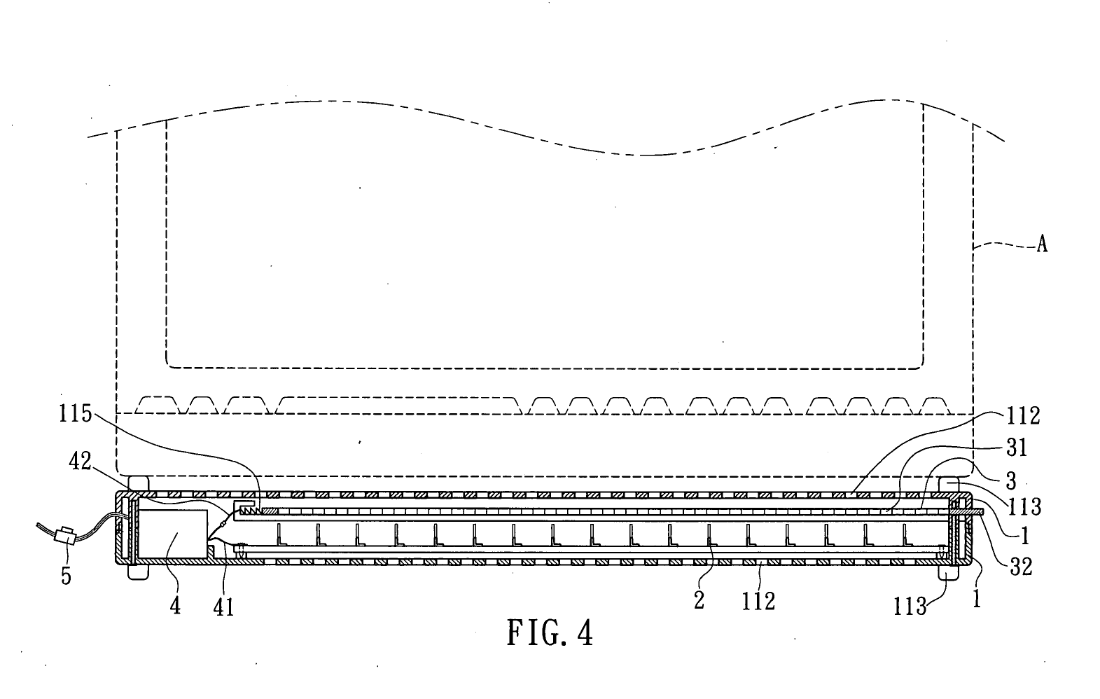

When in use, as shown in FIG. 4, the anion generator is put on the top of the table to support the computer A. By means of the stub rods 113, the housing 1 is spaced above the top of the table and, the computer A is spaced above the housing 1. Therefore, currents of air can flow through the space between the top of the table and the housing 1 of the anion generator and the space between the housing 1 of the anion generator and the bottom side of the computer A. When switched on power supply, the anion-generating panel 2 is driven to generate currents of anions that pass through the three-dimensional meshes 31 of the metal mesh plate 3 to carry heat away from the bottom side of the computer A, thereby lowering the working temperature of the computer A. The three-dimensional meshed 31 of the metal mesh plate 3 concentrates the floxving of the produced currents of anions, thereby improving heat convection effect. Because the flowing currents of anions do not cause much noise, the anion generator of the present invention works silently. During working, the anion generator does not consume much electric energy. Further, because the metal mesh plate 3 is connected to the positive lead wire 42 of the high voltage generator 4, it collects dust during the operation of the anion generator.

As an alternate form of the present invention, the aforesaid mesh plate can be an insulative plate member covered with a carbon fiber conducting layer.

A prototype of anion generator has been constructed with the features of FIGS. 1˜4. The anion generator functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

1. An anion generator comprising:
a housing, said housing having a top side, a bottom side, and a plurality of air vents in said top side and said bottom side;
an anion-generating panel mounted inside said housing adjacent to said bottom side;
a meshed conducting plate mounted inside said housing adjacent to said top side, said meshed conducting plates having a plurality of three-dimension meshes; and
a high voltage generator mounted inside said housing, said high voltage generator having a positive lead wire connected to said meshed conducting plate and a negative lead wire connected to said anion-generating panel for causing said anion-generating panel to generate currents of anions when electrically connected.

2. The anion generator as claimed in claim 1, wherein said housing comprises an insertion hole in one end thereof, and two sliding grooves arranged in parallel in communication with said insertion hole; said meshed conducting plate is inserted through said insertion hole into said sliding grooves.

3. The anion generator as claimed in claim 1, wherein the positive lead wire of said high voltage generator has an outer end provided with a metal spring member and fixedly mounted inside said housing for the contact of said meshed conducting plate.

4. The anion generator as claimed in claim 1, wherein said housing comprises a plurality of stub rods respectively symmetrically provided at said top side and said bottom side on the outside of said housing.

5. The anion generator as claimed in claim 1, wherein said meshed conducting plate is comprised of an insulative plate member and a carbon fiber conducting layer covered on said insulative plate member.

6. The anion generator as claimed in claim 1, wherein said meshed conducting plate has an outer end provided with an insulative member for the gripping of the hand.

7. The anion generator as claimed in claim 1, further comprising a power control electrically connected to said high voltage generator for power on/off and voltage level control.
